(19) United States
(12) Patent Application Publication
(10) Pub. No.: US 2010/0272017 A1
(43) Pub. Date: Oct. 28, 2010

(54) METHOD AND APPARATUS FOR PROCESSING ADVANCED LONG TERM EVOLUTION SYSTEM INFORMATION

(75) Inventors: Stephen E. Terry, Northport, NY (US); Paul Marinier, Brossard (CA); Peter S. Wang, East Setauket, NY (US); Jean-Louis Gauvreau, La Prairie (CA); Guodong Zhang, Syosset, NY (US)

Correspondence Address: VOLPE AND KOENIG, P.C.;DEPT. ICC, UNITED PLAZA, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/762,460

(22) Filed: Apr. 19, 2010

Related U.S. Application Data
(60) Provisional application No. 61/172,062, filed on Apr. 23, 2009.

(51) Int. Cl. H04W 68/02

(52) U.S. Cl. 370/328

(57) ABSTRACT

A method and apparatus for processing advanced long term evolution (LTE-A) system information (SI) are described. When a wireless transmit/receive unit (WTRU) is in an idle mode/state, an LTE-A SI broadcast may be received on at least one downlink (DL) anchor carrier, including a physical DL shared channel (PDSCH) having paging message content. At least one SI-change parameter included in the paging message content may be decoded and processed. The SI-change parameter may include a flag used to indicate an SI change on a logical partition, (a primary or a secondary SI broadcast group information change). When the WTRU is in a connected mode/state, an LTE-A SI-CHANGE-radio network temporary identifier (RNTI) transmission may be received during a modification period (MP), and an SI change may be performed during a subsequent MP. At least one SI-change parameter included in the SI-CHANGE-RNTI transmission may be decoded and processed.

### CROSS REFERENCE TO RELATED APPLICATIONS

This application claims the benefit of U.S. Provisional Application No. 61/172,062, filed Apr. 23, 2009, which is incorporated by reference as if fully set forth.

### FIELD OF INVENTION

This application is related to wireless communications.

### BACKGROUND

In order to support higher data rates and enhance spectrum efficiency, the third generation partnership project (3GPP) long term evolution (LTE) system has been introduced into 3GPP release 8 (R8). For the LTE downlink (DL) direction, a transmission scheme based on an orthogonal frequency division multiple access (OFDMA) air interface is used. According to OFDMA, a wireless transmit/receive unit (WTRU) may be allocated by an evolved Node-B (eNB) to receive its data anywhere across the entire LTE transmission bandwidth. For the LTE uplink (UL) direction, single-carrier (SC) transmission is used based on discrete Fourier transform-spread-OFDMA (DFT-S-OFDMA), or equivalently, single carrier frequency division multiple access (SC-FDMA). A WTRU will transmit in the LTE UL direction only on a limited, yet contiguous set of assigned sub-carriers in an FDMA arrangement.

FIG. 1 illustrates the mapping of a transport block 10 to an LTE carrier 20, for UL or DL transmission. Layer 1 (L1) 30 receives information from a hybrid automatic repeat request (HARQ) entity 40 and a scheduler 50, and uses it to assign a transport block 10 to the LTE carrier 20. As shown in FIG. 1, a UL or DL LTE carrier 20, or simply a carrier 20, is made up of multiple sub-carriers 60. An eNB may receive a composite UL signal across the entire transmission bandwidth from one or more WTRUs at the same time, where each WTRU transmits on a subset of the available transmission bandwidth or sub-carriers.

An advanced LTE (LTE-A) system is currently being developed by the 3GPP standardization body in order to further improve achievable throughput and coverage of LTE-based radio access systems, and to meet the international mobile telecommunications (IMT) advanced requirements of 1 Gbps and 500 Mbps in the DL and UL directions, respectively. Among the improvements proposed for LTE-A are carrier aggregation and support of flexible bandwidth arrangements. An LTE-A cell is much wider than an LTE cell, up to 100 MHz.

As shown in FIG. 2, an LTE-A cell 70 from an eNB consists of several component carriers (CCs) 75₁-75₅, (i.e., frequency carriers), that a legacy cell would normally use. This is referred to as the LTE-A spectrum aggregation (i.e., multi-carrier aggregation) for an LTE-A cell. An LTE-A cell may be considered equivalent to a carrier set.

One or more anchor carriers (e.g., 75₃ and 75₅) may exist among the CCs. The anchor carrier may serve to guide through a WTRU LTE-A cell search and to facilitate the WTRU to synchronize with, and obtain information from, the LTE-A cell 70.

Given that an LTE-A cell (or a carrier set) from an eNB will be deployed with multiple CCs and, as shown in FIG. 3, the CCs may be configured to be an LTE-A-only carrier, (i.e., non-backward compatible), or an LTE-A carrier but backward compatible. A “backward compatible” CC in LTE-A has the full R8 functionality, but may also have some LTE-A extension functionalities as well, (i.e., the backward compatible CC should be equivalent to an LTE-A backward compatible CC). An LTE-A non-backward compatible CC is not accessible to R8 WTRUs. Thus, they are LTE-A-only CCs, which may be used for anchor carriers since backward compatible CCs transmit system information (SI).

As shown in FIG. 3, a carrier-aggregated LTE-A cell with n DL carriers may be split into two different types of carriers; a first group of LTE-A backward compatible carriers D1 to Dk (k<=n), and a second group of LTE-A non-backward compatible carriers Dk+1 to Dn, anchor and non-anchor carriers.

LTE-A cell deployment scenarios affect how the LTE-A WTRUs are operating in an LTE-A cell where LTE-A-only carriers, or LTE-A-only carriers and backward compatible carriers, are deployed. These different deployment scenarios also affect SI broadcast schemes and mechanisms.

### SUMMARY

A method and apparatus for processing advanced LTE-A system information (SI) are described. When a WTRU is in an idle mode/state, an LTE-A SI broadcast may be received on at least one DL anchor carrier, including a physical DL shared channel (PDSCH) having paging message content. At least one SI-change parameter included in the paging message content may be decoded and processed. The SI-change parameter may include a flag used to indicate an SI change on a logical partition, (a primary or a secondary SI broadcast group information change). When the WTRU is in a connected mode/state, an LTE-A SI-CHANGE-radio network temporary identifier (RNTI) transmission may be received during a modification period (MP), and an SI change may be performed in accordance with the SI-CHANGE-RNTI transmission during a subsequent MP. At least one SI-change parameter included in the SI-CHANGE-RNTI transmission may be decoded and processed.

### BRIEF DESCRIPTION OF THE DRAWINGS

A more detailed understanding may be had from the following description, given by way of example in conjunction with the accompanying drawings wherein:

FIG. 1 shows conventional mapping of a transport block to an LTE carrier;

FIG. 2 shows a conventional carrier aggregated LTE-A cell;

FIG. 3 shows conventional cell deployment with LTE-A backward compatible carriers and LTE-A non-backward compatible carriers;

FIG. 4 shows an example of a wireless communication system including a plurality of wireless transmit/receive units (WTRUs) and an eNB;

FIG. 5A show an example of a functional block diagram of the WTRUs and eNBs of FIG. 4;

FIG. 5B shows various channels that facilitate wireless communication between the WTRUs and eNBs of FIG. 4;

FIGS. 6 and 7 show spacing of SI updates;

FIG. 8 shows a block diagram of a WTRU that receives, decodes and processes SI updates;

FIG. 9 shows a flow diagram of a procedure, implemented by the WTRU of FIG. 8 while in an idle mode/state, for processing SI; and

FIG. 10 shows a flow diagram of a procedure, implemented by the WTRU of FIG. 8 while in a connected mode/state, for processing SI.

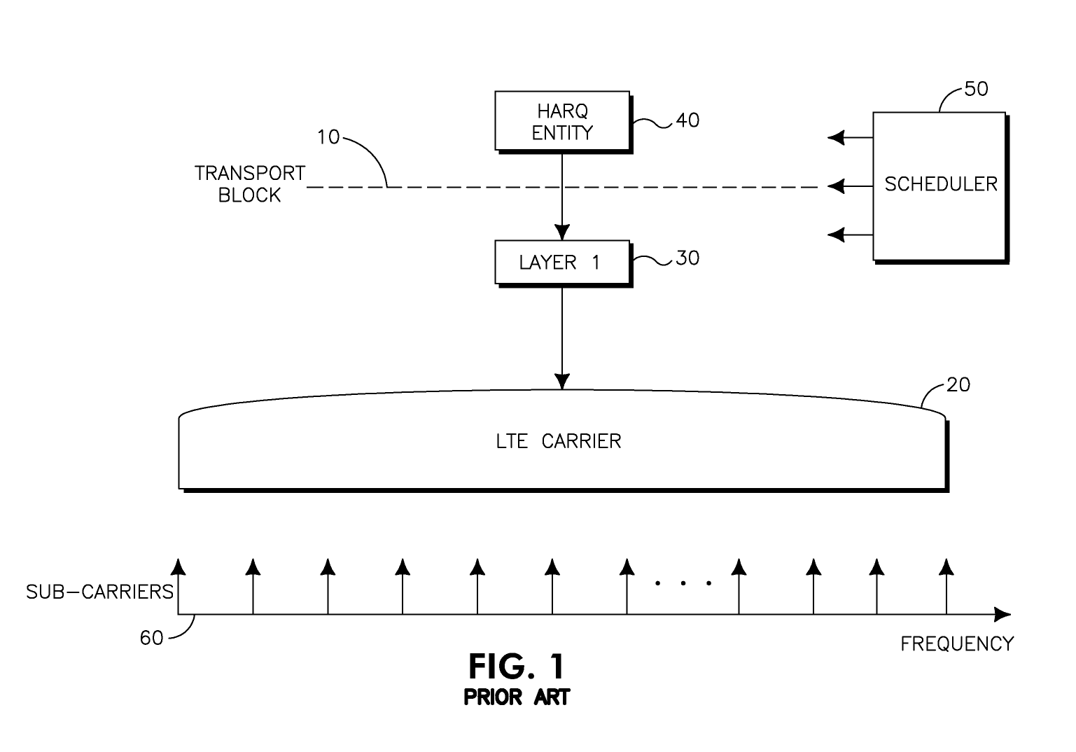

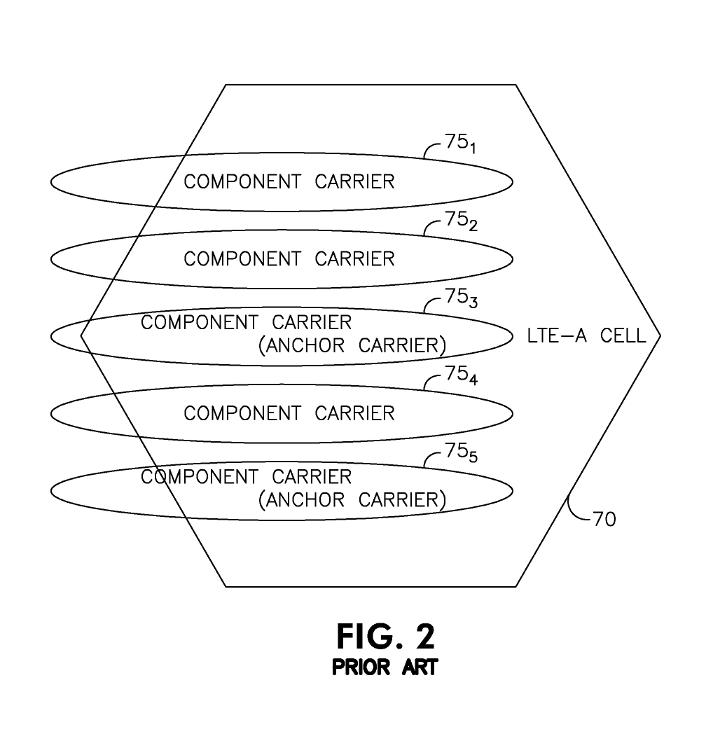

### DETAILED DESCRIPTION

When referred to hereafter, the terminology “wireless transmit/receive unit (WTRU)” includes but is not limited to a user equipment (WTRU), a mobile station, a fixed or mobile subscriber unit, a pager, a cellular telephone, a personal digital assistant (PDA), a computer, or any other type of device capable of operating in a wireless environment.

When referred to hereafter, the terminology “base station” includes but is not limited to a Node-B, an eNB, a site controller, an access point (AP), or any other type of interfacing device capable of operating in a wireless environment.

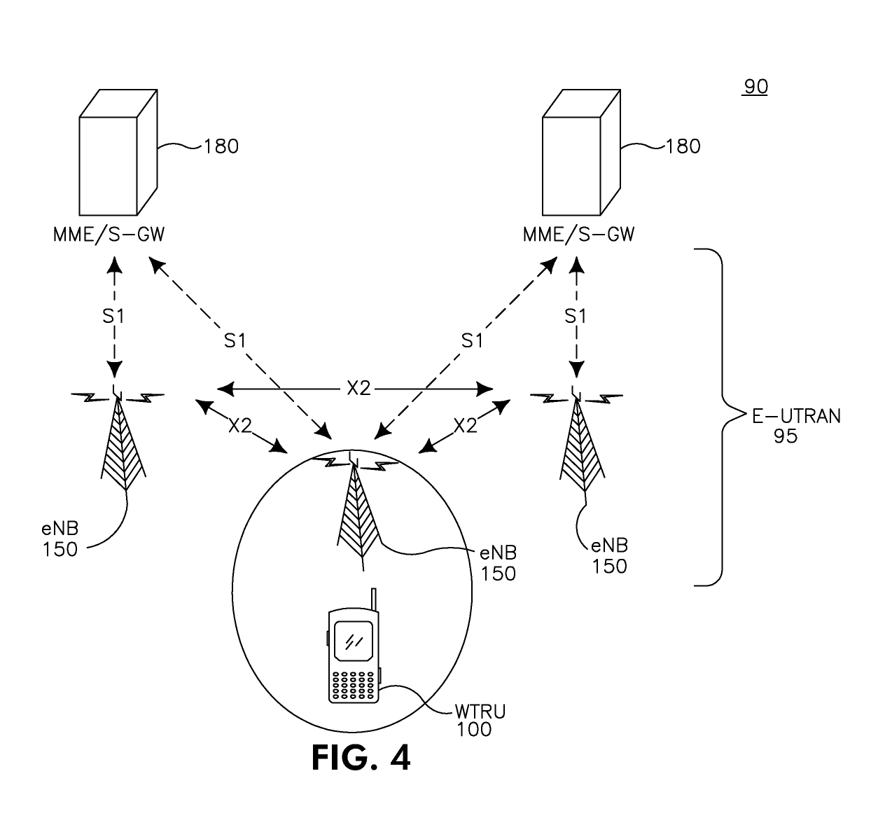

FIG. 4 shows an LTE wireless communication system/access network 90 that includes an evolved-universal terrestrial radio access network (E-UTRAN) 95. The E-UTRAN 95 includes several eNBs 150. A WTRU 100 is in communication with an eNB 150. The eNBs 150 interface with each other using an X2 interface. Each of the eNBs 150 interface with a mobility management entity (MME)/serving gateway (S-GW) 180 through an S1 interface. Although a single WTRU 100 and three eNBs 150 are shown in FIG. 4, it should be apparent that any combination of wireless and wired devices may be included in the LTE wireless communication system/access network 90.

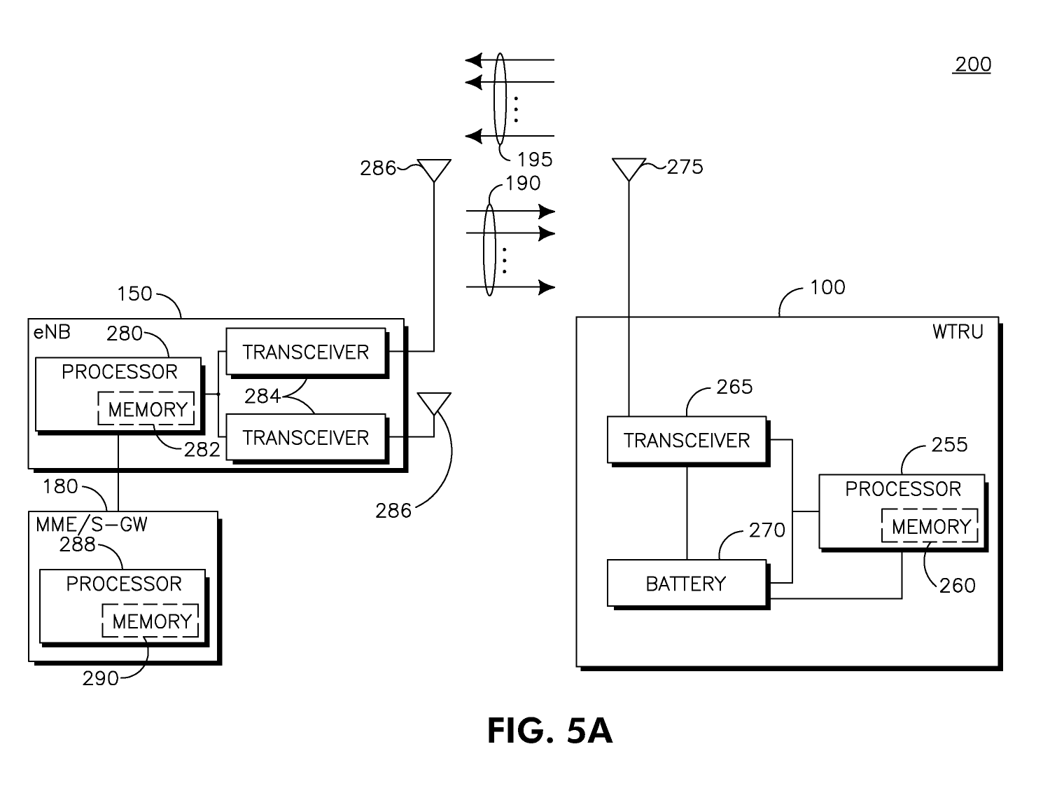

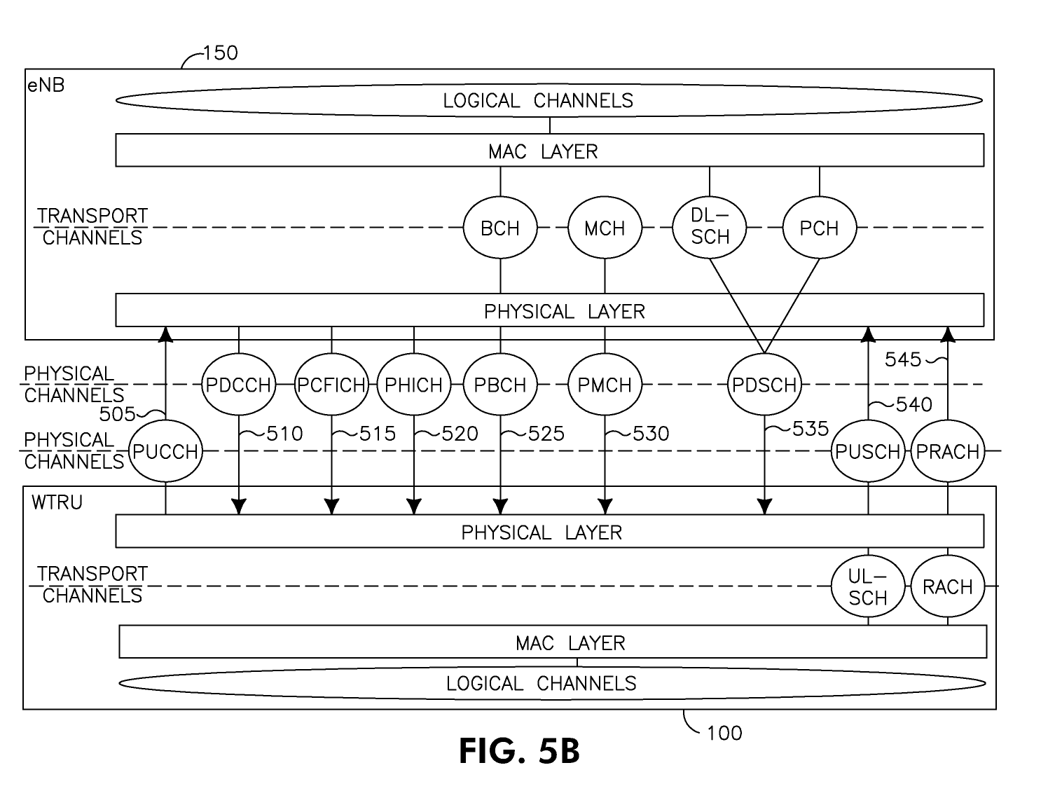

FIG. 5A is an example of a block diagram of an LTE wireless communication system 200 including the WTRU 100, the eNB 150, and the MME/S-GW 180. As shown in FIG. 5A, the WTRU 100, the eNB 150 and the MME/S-GW 180 are configured to process LTE-A SI.

In addition to the components that may be found in a typical WTRU, the WTRU 100 includes a processor 255 with an optional linked memory 260, at least one transceiver 265, an optional battery 270, and an antenna 275. The processor 255 is configured to process LTE-A SI. The transceiver 265 is in communication with the processor 255 and the antenna 275 to facilitate the transmission and reception of wireless communications. In case a battery 270 is used in the WTRU 100, it powers the transceiver 265 and the processor 255.

In addition to the components that may be found in a typical eNB, the eNB 150 includes a processor 280 with an optional linked memory 282, transceivers 284, and antennas 286. The processor 280 is configured to process LTE-A SI. The transceivers 284 are in communication with the processor 280 and antennas 286 to facilitate the transmission and reception of wireless communications. The eNB 150 is connected to the MME/S-GW 180, which includes a processor 288 with an optional linked memory 290.

As shown in FIG. 5A, the WTRU 100 is in communication with the eNB 150, and both are configured to process LTE-A SI, wherein UL transmissions from the WTRU 100 are transmitted to the eNB 150 using multiple UL carriers 190, and DL transmissions are handled using multiple DL carriers 195.

FIG. 5B shows various physical channels that facilitate wireless communication between the WTRUs 100 and eNBs 150 of FIG. 4. The physical channels include a physical UL control channel (PUCCH) 505, a physical DL control channel (PDCCH) 510, a physical control format indicator channel (PCFICH), a physical hybrid automatic repeat request (HARQ) indicator channel (PHICH) 520, a physical broadcast channel (PBCH) 525, a physical multicast channel (PMCH) 530, a physical DL shared channel (PDSCH) 535, a physical UL shared channel (PUSCH) 540, and a physical random access channel (PRACH) 545.

LTE-A Cell Deployment Scenarios and SI Broadcast

Given the differences in the component carriers, an LTE-A cell may be dynamically configured to have the following deployment scenarios.

A carrier-aggregated LTE-A cell with only non-backward compatible carriers will have one or more carriers configured as the cell-specific anchor carriers. The remaining carriers are non-anchor carriers for high rate data operation. An SI broadcast may be configured only on anchor carriers, or on anchor carriers plus a joint broadcast channel. A joint broadcast channel in a carrier-aggregated LTE-A cell broadcasts the common (non-carrier-specific) SI for that cell. The WTRUs may retrieve the joint broadcast channel for the common SI on occasions (i.e., time periods) and locations (i.e., frequency carrier information) specified by the joint PDCCH, or from the PDCCP on its anchor carrier or its primary CC. Thus, the joint broadcast channel may locate on one of the anchor carriers in the cell, or locate on one non-anchor carrier in the cell as high speed data.

When LTE-A carrier deployment is implemented, SI is broadcast on every DL carrier in its entirety. SI broadcast scheduling may be the same. SI content may be different per carrier on different carriers. WTRUs are initially camped on cell-specific anchor carriers in an idle mode/state. WTRUs may be assigned/configured to operate on one or more carriers, (with or without the original anchor carrier), when entering or during the connected mode/state and reading any SI that is carrier specific, and that is present as required.

A carrier-aggregated LTE-A cell may include backward compatible carriers (mixed with LTE-A-only carriers). The backward compatible carriers may be used as cell-specific anchor carriers, but not used for non-anchor carriers for data operation.

When an SI broadcast is only on anchor carriers, the only anchor carriers may be LTE-A backward compatible carriers; or on LTE-A-only anchor carriers, and LTE-A backward compatible anchor carriers.

SI may be broadcast on every DL carrier in its entirety. All broadcast carriers may be LTE-A backward compatible carriers, or they be the LTE-A-only anchor carriers and the LTE-A backward compatible carriers.

LTE-A backward compatible carriers carry legacy SIs or SI blocks (SIBs) and possibly new specific SI as described below.

A conventional WTRU may select one of the LTE-A backward compatible carriers as a WTRU specific anchor carrier and use any of the LTE-A backward compatible carriers. A new WTRU may select an LTE-A non-backward compatible anchor carrier as a WTRU specific anchor carrier, but not an LTE-A non-backward compatible non-anchor carrier. A legacy WTRU cannot use any of the LTE-A non-backward compatible carriers.

The LTE-A cell deployment scenarios may be dynamically reconfigured based on network (eNB) criteria such as traffic patterns and the number of currently camped WTRUs within the cell. To change the deployment scenario, it is not necessary to reconfigure all carriers or the assignment of anchor carriers. Individual carriers may be reconfigured to distribute SI without effecting the configuration of other operational carriers. This allows for reconfiguration of the cell deployment scenario without necessarily effecting active connections and traffic within the cell.

Additionally it should be possible to redistribute carriers between cells. Within the set of carriers controlled by an eNB, subsets of carriers may be assigned and reassigned as necessary to different logical cells. Each cell provides unique SI. As carriers are reassigned, SI is reconfigured for the cell it is associated with. When one or more anchor carriers exist for a particular cell it is possible to only adjust SI on these carriers to support the carrier added or removed from the cell. When the cell being relocated between carriers provides SI, the SI on this carrier is reconfigured to be aligned with the new cell it is assigned.

SI Broadcast on an LTE-A Cell Specific Anchor Carrier

In this cell deployment scenario, the SI can be broadcast only on the cell specific anchor carrier(s). SI is not broadcast on the non-anchor carriers in the cell. Therefore it may only be possible for a backward compatible WTRU to camp on the anchor carrier(s) if the carrier is a backward compatible component carrier.

An LTE-A WTRU performing cell search may find the LTE-A-only cell specific anchor carrier(s) and when camping on an anchor carrier of an LTE-A cell, the WTRU reads the master information block (MIB) and other SIBs from the anchor carrier. If there is no backward compatibility issues, (i.e., on an LTE-A-only anchor carrier), the LTE-A SI may be formed, scheduled and transmitted and received in the most suitable way for the LTE-A system, while maintaining the traits of a typical LTE, (i.e., single carrier legacy LTE system), network.

If more than one cell specific anchor carrier can be configured, the SI contents on each different anchor carrier may be different. This may affect the SI transmission scheduling.

Scheduling

For an LTE-A-only anchor carrier, the SI contents may increase and the available bandwidth may also change with respect to the current SI broadcast scheme. To cope with the new SI contents and to maintain the SI-window based scheduling in LTE, flexible SI-window size may be used in LTE-A.

Flexible transmission window length may be configured by the network. The SI-window size is specifically signaled with each SI (or independent SIB) in the schedulingInfo information element (IE) list. The IE entry contains the {periodicity, SI-windowSize, SI-mapping} where the SI-windowSize may be different and is defined for each IE. The first IE in the list must contain the SI-windowSize parameter, but if the SI-windowSize is not present in subsequent entries, the WTRU will take the SI-windowSize value from the previous entry.

The SI-windowSize may also be implied by the periodicity of the SI. The shorter the periodicity, the smaller the transmit window, (i.e., the SI-window is Wx (in subframes), for periodicity Px (in milli-seconds), where x is an integer (i.e., 1, 2, 3 . . . ) to distinguish the different possible SI periodicities. Alternatively, the SI-window size remains the same for all legacy SI messages, but one or more different SI-window sizes (or a different set of SI-windows) may be used for additional SI messages or SIB types defined for LTE-A.

The above procedures may also be used in any type of carrier, (either backward compatible or non-backward compatible), for new SIB types defined for LTE-A WTRUs. This may be realized by using one of the procedures described below to make the transmission of a future system or LTE-A SI transparent to legacy WTRUs.

Specific LTE-A Contents in SI Broadcast

Specific LTE-A SI contents, (in MIB or SIB-1 or other SIBs, SIB location not restricted), may include an LTE-A cell DL/UL component carrier combination or combinations information for publishing all the component carriers in the LTE-A cell (anchor or not, PDCCH) deployed, UL access carriers that support UL access, or intra-cell anchor carrier reselection).

Specific LTE-A SI contents, (in MIB or SIB-1 or other SIBs, SIB location not restricted) for one or more DL component carriers (the order can be used as the carrier-ID within the LTE-A cell), may include bandwidth (allow for a different bandwidth carrier to be used) and frequency (center or representative evolved absolute radio frequency channel number (EARFCN)) of each carrier, cell-specific anchor carrier or not, backward compatible carrier, reselection priority (if anchor carrier reselection is supported), default paging discontinuous reception (DRX) cycle (may be different among anchor carriers), PDCCH information on the carrier (e.g., the joint PDCCH for the cell, a regular PDCCH with the carrier (may be backward compatible), or no PDCCH in the DL carrier (non-backward compatible)), PDCCH DRX information for carriers with PDCCH, and a specification of the control region in an LTE-A non-backward compatible carrier. The DL component carriers may also contain UL carrier information specified below.

Specific LTE-A SI contents, (in MIB or SIB-1 or other SIBs, SIB location not restricted), for one or more UL component carriers, (the order may be used as the carrier-ID with the LTE-A cell), may include UL carrier information for WTRUs camped/assigned on the current carrier, such as all accessible UL carriers, (list of UL carriers for this DL carrier or cell ID), assigned one-to-one UL carriers for random access (carrier-ID), assigned one-to-more UL carriers for random access (carrier-IDs). The UL access carrier information (for this DL carrier or set of DL carriers within the cell) may include random access configurations for access operation, and PUCCH access information including association with particular DL carriers.

Specific LTE-A SI contents, (in MIB or SIB-1 or other SIBs, SIB location not restricted) for one or more UL component carriers (the order may be used as the carrier-ID with the LTE-A cell), may also include bandwidth and frequency (center or flag EARFCN) of each carrier, cell-specific anchor carrier or not, and PUCCH information, (regular PUCCH with the carrier (DL carrier identification), no PUCCH on the carrier, or joint PUCCH, (list of associated DL carriers).

Neighbor Cell List May Contain Anchor Carrier Information

In order to facilitate the inter-cell reselection on anchor carriers (whether between intra-frequency LTE-A cells or between inter-frequency LTE-A cells), the neighbor cell's carriers and/or anchor carriers may be listed in the neighbor cell list (NCL) in the SI broadcast. The carrier and/or anchor carrier parameters include the frequency and bandwidth of the anchor carrier, reselection priority, and PDCCH and physical random access channel (PRACH) as the DL/UL paring information.

Cell Access Parameters in LTE-A

The following cell access parameters may appear in the LTE-A SI broadcast: cellBarred (“barred” or “not barred”), cellReservedForOperatorUse (“reserved” or “not reserved”), and intraFreqReselection (“allowed” or “not allowed”). If more than one cell-specific anchor carriers is deployed in the cell, additional parameters may be defined for LTE-A cell SI broadcast as: anchorCarrierBarred (“barred” or “not barred”), and intraCellReselection (“allowed” or “not allowed”).

If the cellBarred is “not barred” and the cellReservedForOperatorUse is “not reserved” and the anchorCarrierBarred is “not barred”, the WTRU may select to camp on this anchor carrier. However, if the anchorCarrierBarred is “barred”, then the WTRU cannot select or reselect to this anchor carrier. The WTRU may keep searching for a different anchor carrier in this LTE-A cell or searching for a different carrier/cell according to the value of the intraCellReselection parameter.

If the is intraCellReselection is “allowed”, the WTRU can search for another anchor carrier within the cell; if the intraCellReselection is “not allowed” the WTRU cannot search for another anchor carrier within the cell. The WTRU will have to look at the intraFreqReselection parameter to determine whether an intra-frequency searching should be performed or not.

LTE-A SI Broadcast Partitioning Scheme

The following scheme may apply to an LTE-A carrier only cell or an LTE-A mixed carrier cell.

In an LTE-A deployment scenario where the LTE-A cell assigns one or more anchor carriers as the cell specific anchor carriers, and the cell-specific anchor carrier handles all the idle mode/state WTRU's services for the cell while one or more non-anchor carriers are assigned to service the WTRUs in a connected mode/state, the SI broadcast may be performed as follows.

All of the SIBs for the particular cell are broadcast on the anchor carrier including information about the non-anchor carriers aggregated for bandwidth extension. WTRUs obtain all SI from the anchor carrier it camps on. There is no reception of SI on non-anchor carriers for LTE-A compatible WTRUs.

Alternatively, only the most essential SI is broadcast on the anchor carrier (the primary-SI-broadcast-group) to reduce the SI transmission overhead and to allow anchor carrier specific SI content. All of the remaining SI is broadcast on a joint SI broadcast channel or specific resources allocated/configured by the LTE-A cell (the secondary-SI-broadcast-group). The most essential SI broadcast on the anchor carrier, (i.e., the primary-SI-broadcast-group), includes public land mobile network (PLMN)-IDs/tracking-area-ID/macro-cell/closed subscriber group (CSG)-cell identities, the various service support indicators and the network/non-access stratum (NAS) SI, the cell/carrier selection information, the cell/carrier access restriction information, the scheduling information to obtain all the rest of the SIBs and, optionally, the paging reception information and the random access information.

Only the anchor carrier distributes cell specific SI, and SI for the anchor carrier itself. Non-anchor carriers distribute a subset of SI that only includes information necessary for the non-anchor carriers. These non-anchor carriers are not backward compatible.

Under this deployment scheme, the inter-cell handover among LTE-A cells may need the handover (HO) command to specify not only the resources continuously to be used in the target cell for data transfer, but may also need to specify an anchor carrier address explicitly (EARFCN) or implicitly (the anchor carrier whose frequency is next (or closest) to the current data carrier frequency with either a positive or a negative offset) in the HO command.

Joint Broadcast Channel Schemes

In a scheme for a joint broadcast channel/facility, all WTRUs in the LTE-A cell would check the joint PDCCH for the SI broadcast signal (i.e., the SI-RNTI or some other RNTI) to perform the SI reception on a joint broadcast channel (e.g., a PDSCH or other DL resources).

All common SI content, which is not carrier specific, is broadcast in the joint broadcast channel, except the directives to the joint PDCCH and the carrier specific SI. The directives to the joint PDCCH may be included in an MIB or a carrier-specific SIB (e.g., SIB-1) on the respective component carriers or anchor carriers as a frequency or a frequency offset with respect to the anchor or an LTE physical resource block (PRB) address, and the number or the range of the resource blocks. Other carrier specific SI may also be put in the carrier-specific SIB on the respective component carriers or anchor carriers.

By employing such a joint broadcast resource facility/channel in an LTE-A cell, a larger frequency resource may be configured towards the SI broadcast on the same component carrier or on different component carriers with the following SI transmission schemes.

More than one copy of the SI-message can be transmitted with a same redundancy version (RV) or different RVs, (e.g., two copies in the same transmission timing interval (TTI) in the combinations of RV=0, 2 and then RV=3, 1, or any other RV combinations) within a subframe/TTI or a basic SI transmit time unit to increase the successful decoding rate.

More SIBs of a same periodicity or more segments of SIB-11, (i.e., one or more segments of the earthquake and tsunami warning system (ETWS) secondary notification), may be combined for an SI-message in an SI-window to achieve time efficiency.

The SI transmission window (SI-window) may thus be shortened by the above procedures to have not more than two effective subframe/TTI or basic SI transmit unit, (excluding the non-SI-subframes, such as those used for multimedia broadcast multicast services (MBMS)). Thus, the SI-window may be configured for flexible lengths for the SI-broadcast to accommodate more SI-messages in the time domain.

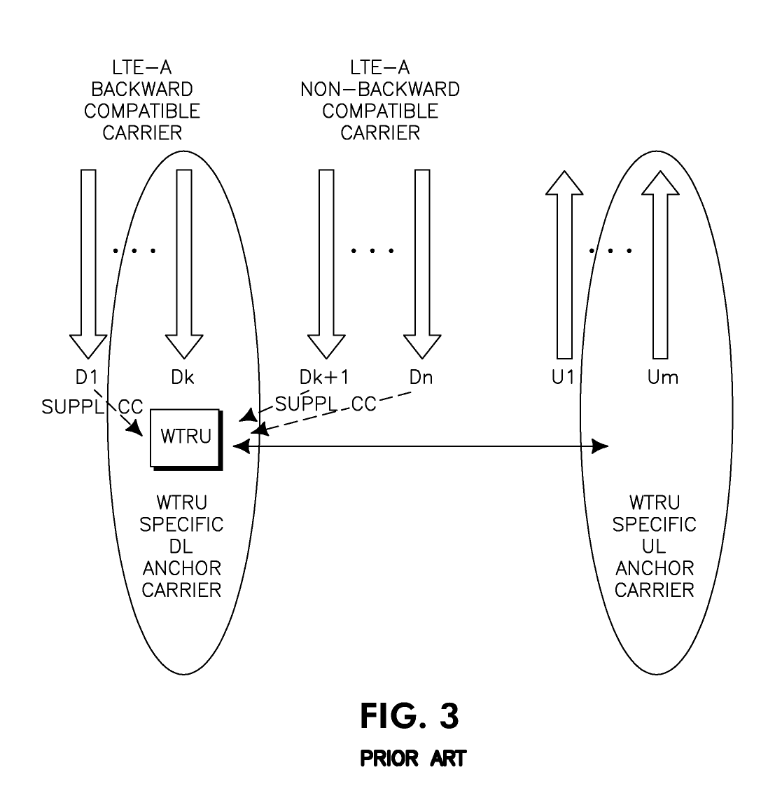

As described previously in FIG. 3, a carrier-aggregated LTE-A cell may be split into two groups of carriers: LTE-A backward compatible carriers (group 1), and LTE-A non-backward compatible carriers (group 2).

LTE-A Backward Compatible Carriers

A first group of carriers, referred previously as LTE-A backward compatible carriers D1 to Dk, carries legacy SI or SIB enabling a legacy WTRU to use any of the LTE-A backward compatible carriers of the group. As previously described, LTE-A specific SIs may be included in this type of carrier.

One approach to provide specific SIs or SIBs to future system compatible WTRUs only, which could be transparent to legacy WTRUs, is to reserve and use a different and additional SI-RNTI to address for future system compatible WTRUs only, referred as the LTE-A_SI-RNTI. Such an LTE-A_SI-RNTI may be predefined or signaled. If the LTE-A_SI-RNTI is pre-defined, one of the “reserved” RNTI values in the legacy system may be used.

For example, when a WTRU is acquiring SI during initial cell selection or reselection, a future system WTRU may search PDCCH candidates in a WTRU common search space. The PDCCH candidate cyclic redundancy check (CRC) matches with the LTE-A_SI-RNTI, DL control information (DCI) is decoded and the WTRU acquires associated information inside about the PDSCH that contains specific LTE-A SI as described above.

It is clear from this procedure that legacy WTRUs may not detect the LTE-A_RNTI in PDCCH as a candidate, since it is using a different SI-RNTI in the same WTRU common search space. A future system WTRU would still use the legacy SI-RNTI as needed to acquire backward compatible SIs or SIBs.

Alternatively, a future system WTRU could search a PDCCH candidate outside the legacy WTRU common search space. In other words, a specific common search space could be defined for future system WTRUs, so that only future system WTRUs would search this search space using the same SI-RNTI for LTE-A SIs or SIBs.

Another approach is to send future system specific SIs or SIBs only during certain subframes which are reserved to LTE-A WTRUs. One scheme to support this is to use multicast/broadcast on single frequency network (MBSFN) subframe blanking. For such a subframe, legacy WTRUs are only requested to monitor the control region for a UL grant in the WTRU-specific search space using its assigned cell RNTI (C-RNTI) address or semi-persistent scheduling (SPS) C-RNTI, or capture a PHICH for UL transmission feedback. Therefore, the network could safely send SI using the SI-RNTI, since only the future system WTRU may search for PDCCH candidates in the WTRU common search space for the subframes. It is possible that only a subset of MBSFN subframes is used to transmit future system-specific SI. The subset of MBSFN subframes used for this purpose may be signaled as a non-critical extension in one of the existing SIB types (e.g., SIB2, which already contains the IEs related to the MBSFN subframes). Such non-critical extensions would be ignored by legacy WTRUs.

Scheduling information for future system-specific (or LTE-A specific) SIs may be sent over the same SIB1 (already used for legacy SI) as a non-critical extension, using the same SI-RNTI as for legacy SI. Such scheduling information is ignored by legacy WTRUs. Alternatively, scheduling information for future system-specific SI may be sent over a new SIB (i.e., SIB1A). This SIB1A may be made transparent to legacy WTRUs by using a different SI-RNTI as described above, which could be pre-defined or received from a non-critical extension of an SIB, and/or transmitting into a distinct subset of sub-frames compared to the (legacy) SIB1. This subset of sub-frames may be predefined or signaled from an existing SIB (such as a non-critical extension of SIB1).

LTE-A Non-Backward Compatible Non-Anchor Carriers

Some or all of the second group of carriers, referred to previously as LTE-A non-backward compatible carriers Dk+1 to Dn, do not carry legacy SIs or SIBs. Thus, they cannot be used as anchor carriers (or primary CCs). This type of carriers cannot be used by a legacy WTRU, or be selected as a WTRU-specific anchor carrier for future system WTRUs. The other type of carriers is the LTE-A-only anchor carriers discussed previously.

Non-backward compatible non-anchor carriers may not contain any control region. This would allow all 14 symbols of a given subframe (in the case of normal cyclic prefix) to be used for PDSCH. Thus, these carriers may not carry any PHICH, PCFICH or PDCCH channels. In order to support this, multi-carrier grants would be received in the control region of the WTRU-specific anchor carrier to define the PDSCH resources to be used in non-backward compatible carriers, as shown in FIG. 3. Since no control region is allowed on these type of carriers, SIB carried over these channels will have to be granted in the control region of the WTRU-specific anchor carrier.

Alternatively, the PHICH channel and common reference symbols may be included in the first symbol of the LTE-A non-backward compatible carriers. This would allow having the remaining 13 symbols of a given subframe (in the case of normal cyclic shift) to be used for PDSCH. The PCFICH may be omitted in this case, since the WTRU may determine that only the first symbol is used for the control region.

It is also possible that a non-backward compatible non-anchor carrier uses a control region as in a normal legacy carrier, but legacy SI is not broadcast from this carrier. Such an arrangement has the benefits that legacy WTRUs are not disturbed by a change of SI specific to LTE-A, and in addition may allow a better load sharing of SI between the carriers. An LTE-A WTRU may receive LTE-A-specific SI from such a carrier by monitoring the PDCCH from this carrier. The scheduling information for this LTE-A-specific SI may be received from this carrier (and for instance contained in a new SIB type (1A) or an extended SIB type 1), or may be received from another carrier. The modification period used for the LTE-A SI in this carrier may be different (e.g., larger) than the modification period used in the carrier from which legacy SI is received, so that the WTRU is not forced to turn on its receiver as often for this carrier to monitor the PDCCH for the paging that could contain an indication of SI change for this LTE-A-specific SI.

On a condition that it is desired to use an anchor carrier, (backward compatible or LTE-A-only), for a “non-anchor” type of high-speed data operations, and in order to prevent legacy WTRUs from attempting to camp on and access such carriers, the network, for example, may set the “cellBarred” IE contained in SIB1 to “barred”. Future system WTRUs ignore the content of this IE for cell barring determination purposes, and determine whether the cell is barred based on the value of a new IE (“cellBarred-R10”), which is added as a non-critical extension to a SIB, such as SIB1.

SI Change Notification Procedures for the LTE-A

A regular LTE paging message with an SI-change notification indicator/IE or a signal on PDCCH with a special RNTI, (i.e., an SI-CHANGE-RNTI transmission), may be used to provide an SI change notification.

In a mixed procedure, an SI-change notification is sent with a paging message only on the cell-specific anchor carriers to idle mode/state WTRUs, that are also monitoring real incoming calls. The SI-change notification may be included in an SI-CHANGE-RNTI transmission over relevant PDCCHs for connected mode/state WTRUs that monitor the SI change sign only with a lighter processing effort on the WTRU without being concerned with the monitoring occasions in time associated with WTRU-ID for a paging record.

In a uniform procedure, the SI-change notification is sent on all DL anchor carriers, and the WTRU is notified about the SI-change on one or more carriers. When in an idle mode/state and camped on the anchor carrier, (cell specific anchor carrier), the WTRU checks the PDCCH over the anchor carrier. Alternatively, the WTRU checks the PDCCH relevant to the WTRU connected state, i.e. the base carrier PDCCH where the WTRU receives the PDCCH in the connected mode/state, or checks the joint PDCCH for the LTE-A cell.

The paging message content is in the PDSCH channel whose exact resource location is indicated to the WTRU by the PDCCH-format signaling used with the paging RNTI (P-RNTI) over the PDCCH. The PDSCH may be in the same DL anchor carrier with the relevant PDCCH, or may be in a different DL anchor carrier other than the one with the PDCCH.

In the paging message, an SI-change notification IE is used to indicate an SI-change. If the SI broadcast on different DL anchor carriers in the LTE-A cell is updated, the SI-change carrier needs to be specified, by a carrier-ID or by a representative frequency channel number (e.g., EARFCN). A flag may be used to indicate the SI change on a logical partition, e.g., either a primary-SI-broadcast group change or a secondary-SI-broadcast group content change, if the LTE-A SI broadcast is partitioned into primary and secondary SI-broadcast groups. An individual SIB or SI-message change indicator map (a bitmap or individual flags) may be used to indicate which SIB, SI-message or group of a small number of SIBs/SI messages has been updated. Paging messages (which include the PDCCH with P-RNTI) are sent on different carriers using the same paging formula. Paging messages may have a timing offset on different carriers with respect to one another.

SI Change Notified Via PDCCH Signaling

With the usage of PDCCH for connected mode/state WTRUs, a special signal with contents indicating an SI-change is provided by an SI-CHANGE-RNTI transmission. The SI-CHANGE-RNTI transmission over the respective PDCCH may be synchronized from carrier to carrier, (i.e., the transmission of SI-CHANGE-RNTI and signal contents on all PDCCHs of all DL carriers occur simultaneously). Thus, an SI-CHANGE-RNTI transmission on all DL carriers uses the same scheduling with no time offset. The content of the SI-CHANGE-RNTI transmission on all carriers may be the same, but the SI-CHANGE-RNTI transmission on each carrier may have a different timing offset.

Alternatively, the content of the SI-CHANGE-RNTI transmission may be different, depending on whether the targeted WTRU is in an idle mode/state or a connected mode/state.

The scheduling of SI-CHANGE-RNTI transmissions may be universal for all WTRUs regardless of what mode/state the WTRUs are in, and for all DL carriers carrying a PDCCH. Since SI-CHANGE-RNTI transmissions are only used to indicate an SI change, they do not need to abide to the paging formula paradigm, which is heavily relying on the WTRU-ID and/or the paging group count. Since the SI update happens on the MP boundary, the MP factor may be considered.

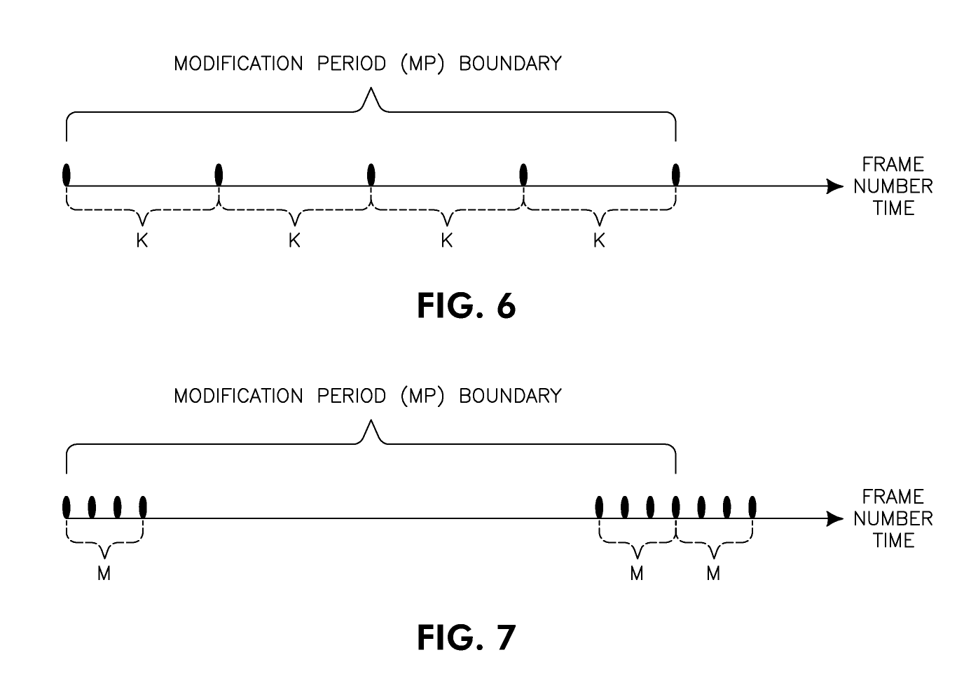

As shown in FIG. 6, the MP boundary at the frames is an LTE system frame number (SFN) mod MP-period. The distribution of the SI-CHANGE-RNTI may be evenly spaced within one MP-period, (i.e., the SI change signal transmitted on a PDCCH includes occasions at LTE frame numbers that are SFN mod(MP−period/K)=0, where K (signaled or specification-defined) is the number of times that an SI-CHANGE-RNTI is transmitted in an MP-period, and it is an integer fraction of the MP-period).

Alternatively, as shown in FIG. 7, SI-CHANGE-RNTI transmissions occur on both ends of the MP boundary, (i.e. the SI-change signal transmitted on a PDCCH includes occasions at LTE frame numbers in a range of {−M, . . . , −1, SFN mod MP-period, +1, . . . , +M}, where M (signaled or specification-defined) is an integer of LTE frames or subframes within which a single subframe periodic (M mod n=0 and one subframe out of n subframes) SI-CHANGE-RNTI transmission occurs, or consecutive subframes (M mod n=0, two or more but less than or equal to n consecutive subframes out of the n (signaled or specification-defined) subframes, may be used to schedule the SI-CHANGE-RNTI transmission.

The SI-CHANGE-RNTI transmission over the PDCCH may be arranged to the next subframe, or to one or two subframes within a few subframes of the paging message transmissions with the P-RNTI over PDCCH. The purpose is to align the SI-CHANGE-RNTI transmission with the P-RNTI such that the WTRU may arrange to check the SI-CHANGE-RNTI transmission with its idle mode/state paging occasions or connected mode/state DRX on-duration plus the active time, in order to save power.

The SI-CHANGE-RNTI transmission content may include an SI-change indicator IE. If the SI broadcast on different DL anchor carriers in the LTE-A cell is updated, the carrier with the SI-change needs to be specified, by a carrier-ID or by a representative frequency channel number (e.g., EARFCN). A flag may be used to indicate the SI change on a logical partition, (e.g., either a primary-SI-broadcast group change or a secondary-SI-broadcast group content change), on a condition that the LTE-A SI broadcast is partitioned into primary and secondary SI-broadcast groups. An individual SIB or SI-message change indicator map (a bitmap or individual flags) indicates which SIB or which SI-message or which group of small number of SIBs/SIs has been updated.

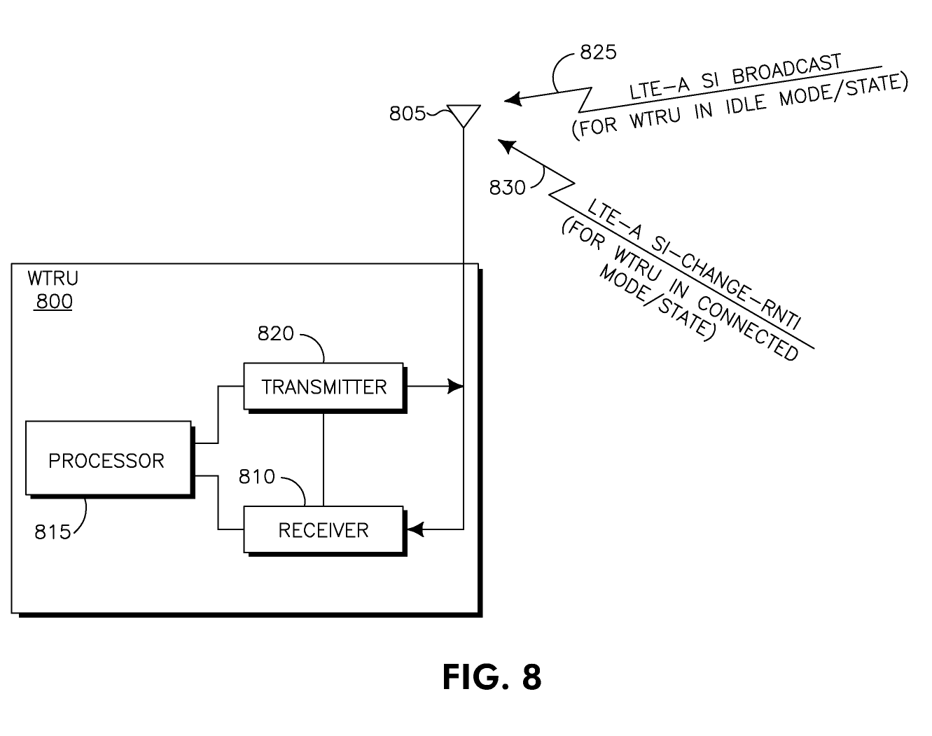

FIG. 8 shows a block diagram of a WTRU 800 that receives, decodes and processes SI updates. The WTRU 800 includes an antenna 805, a receiver 810, a processor 815 and a transmitter 820. The WTRU 800 is configured to receive, decode and process an LTE-A SI broadcast 825 when the WTRU 800 is in an idle mode/state. The WTRU 800 is further configured to receive, decode and process an LTE-A SI-CHANGE-RNTI transmission 830 when the WTRU 800 is in a connected mode/state.

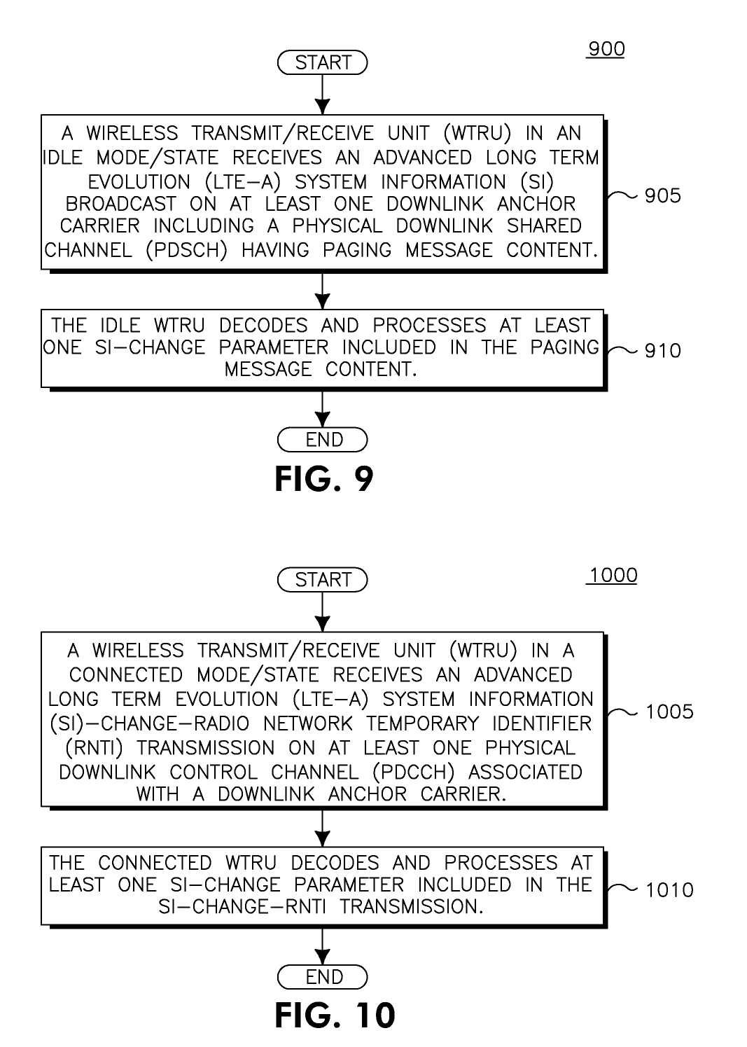

FIG. 9 shows a flow diagram of a procedure 900, implemented by the WTRU 800 of FIG. 8 while in an idle mode or an idle state, for processing SI. Referring to FIGS. 8 and 9, the receiver 810 in the idle WTRU 800 receives an LTE-A SI broadcast via the antenna 805 on at least one DL anchor carrier including a PDSCH having paging message content (905). The processor 815 in the idle WTRU 800 then decodes and processes at least one SI-change parameter included in the paging message content (910).

The SI-change parameter may include an IE that specifies whether or not SI broadcast on different DL anchor carriers in an LTE-A cell is updated.

An SI-change carrier may be specified by the IE using a carrier ID or a frequency channel number, on a condition that the SI is broadcast on different DL anchor carriers in an LTE-A cell.

The same paging message content may be sent on each of the DL anchor carriers at different time periods.

The DL carrier may further include a PDCCH, whereby a resource location of the PDSCH is indicated to the WTRU by PDCCH-format signaling used with a P-RNTI over the PDCCH.

The SI-change parameter may include a flag used to indicate an SI change on a logical partition, (a primary or a secondary SI broadcast group information change).

The SI-change parameter may include an individual SIB or an SI message change indicator map that indicates which SIB, SI message, or group of SIBs or SI messages has been updated.

FIG. 10 shows a flow diagram of a procedure 1000, implemented by the WTRU 800 of FIG. 8 while in a connected mode or a connected state, for processing SI. Referring to FIGS. 8 and 10, the receiver 810 in the connected WTRU 800 receives an LTE-A SI-CHANGE-RNTI transmission on at least one PDCCH associated with a DL anchor carrier via the antenna 805 (905). The processor 815 in the connected WTRU 800 then decodes and processes at least one SI-change parameter included in the SI-CHANGE-RNTI transmission (1010).

The SI_CHANGE_RNTI transmission may occur in LTE frames or subframes of the PDCCH during an MP.

When the WTRU detects an SI change/update, the WTRU may retrieve the information of the changed/updated SI carrier by using either the procedure 900 shown in FIG. 9, or the procedure 1000 of FIG. 10.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (WTRU), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method, implemented by a wireless transmit/receive unit (WTRU) while in an idle mode or an idle state, for processing system information (SI), the method comprising:
receiving an advanced long term evolution (LTE-A) SI broadcast on at least one downlink anchor carrier including a physical downlink shared channel (PDSCH), the PDSCH including paging message content; and
decoding and processing at least one SI-change parameter included in the paging message content.

2. The method of claim 1 wherein the SI-change parameter includes an information element (IE) that specifies whether or not SI broadcast on different downlink anchor carriers in an LTE-A cell is updated.

3. The method of claim 2 wherein an SI-change carrier is specified by the IE using a carrier identifier (ID) or a frequency channel number, on a condition that the SI is broadcast on different downlink anchor carriers in an LTE-A cell.

4. The method of claim 1 wherein the same paging message content is sent on each of the downlink anchor carriers at different time periods.

5. The method of claim 1 wherein the SI-change parameter includes a flag used to indicate an SI change on a logical partition.

6. The method of claim 5 wherein the SI change on the logical partition is either a primary SI broadcast group information change, or a secondary SI broadcast group information change.

7. The method of claim 1 wherein the SI-change parameter includes an individual SI block (SIB) or an SI message change indicator map that indicates which SIB, SI message, or group of SIBs or SI messages has been updated.

8. A method, implemented by a wireless transmit/receive unit (WTRU) while in a connected mode or a connected state, for processing system information (SI), the method comprising:
receiving an advanced long term evolution (LTE-A) SI-CHANGE-radio network temporary identifier (RNTI) transmission on at least one physical downlink control channel (PDCCH) associated with a downlink anchor carrier; and
decoding and processing at least one SI-change parameter included in the SI-CHANGE-RNTI transmission.

9. The method of claim 8 wherein the SI-change parameter includes an information element (IE) that specifies whether or not SI broadcast on different downlink anchor carriers in an LTE-A cell is updated.

10. The method of claim 9 wherein an SI-change carrier is specified by the IE using a carrier identifier (ID) or a frequency channel number, on a condition that the SI is broadcast on different downlink anchor carriers in an LTE-A cell.

11. The method of claim 8 further comprising:
receiving the SI-CHANGE-RNTI transmission during a modification period (MP); and
performing an SI change in accordance with the SI-CHANGE-RNTI transmission during a subsequent MP.

12. The method of claim 8 wherein the SI-change parameter includes a flag used to indicate an SI change on a logical partition.

13. The method of claim 8 wherein the SI change on the logical partition is either a primary SI broadcast group information change, or a secondary SI broadcast group information change.

14. The method of claim 8 wherein the SI-change parameter includes an individual SI block (SIB) or an SI message change indicator map that indicates which SIB, SI message, or group of SIBs or SI messages has been updated.

15. A wireless transmit/receive unit (WTRU) for processing system information (SI) while in an idle mode or an idle state, the WTRU comprising:
a receiver configured to receive an advanced long term evolution (LTE-A) SI broadcast on at least one downlink anchor carrier including a physical downlink shared channel (PDSCH), the PDSCH including paging message content; and
a processor configured to decode and process at least one SI-change parameter included in the paging message content.

16. The WTRU of claim 15 wherein the SI-change parameter includes an information element (IE) that specifies whether or not SI broadcast on different downlink anchor carriers in an LTE-A cell is updated.

17. The WTRU of claim 16 wherein an SI-change carrier is specified by the IE using a carrier identifier (ID) or a frequency channel number, on a condition that the SI is broadcast on different downlink anchor carriers in an LTE-A cell.

18. A wireless transmit/receive unit (WTRU) for processing system information (SI) while in a connected mode or a connected state, the WTRU comprising:
a receiver configured to receive an advanced long term evolution (LTE-A) SI-CHANGE-radio network temporary identifier (RNTI) transmission on at least one physical downlink control channel (PDCCH) associated with a downlink anchor carrier; and
a processor configured to decode and process at least one SI-change parameter included in the SI-CHANGE-RNTI transmission.

19. The method of claim 18 wherein the SI-CHANGE-RNTI transmission is received during a modification period (MP), and an SI change is performed in accordance with the SI-CHANGE-RNTI transmission during a subsequent MP.
